(19) United States
(12) Patent Application Publication
(10) Pub. No.: US 2025/0154434 A1
(43) Pub. Date: May 15, 2025

(54) DISHWASHING DETERGENT COMPOSITION

(71) Applicant: Reckitt Benckiser Finish B.V., Hoofddorp (NL)

(72) Inventors: Alias Younis Al-Bayati, Heidelberg (DE); Kai Werner Heppert, Heidelberg (DE); Torsten Roth, Heidelberg (DE); Itahisa Suarez, Heidelberg (DE)

(21) Appl. No.: 18/838,427

(22) PCT Filed: Feb. 15, 2023
(86) PCT No.: PCT/EP2023/053708

§ 371 Date: Aug. 14, 2024

(30) Foreign Application Priority Data
Feb. 15, 2022 (GB) 2202002.8

(51) Int. Cl. C11D 1/52; C11D 1/722; C11D 1/835; C11D 11/00; C11D 17/04

(52) U.S. Cl. CPC C11D 1/521; C11D 1/722; C11D 1/835; C11D 11/0094; C11D 17/043; C11D 17/045; C11D 2111/14

(57) ABSTRACT

The present invention relates to a package or device comprising a water-soluble container in which is contained a dishwashing detergent composition comprising at least one fatty acid glucamide and at least one fatty alcohol alkoxylate, wherein the composition has a water content of <20 wt. %.

The invention further relates to a method of preparing such a package or device, wherein the method comprising the steps of:
a. Mixing at least one fatty acid glucamide with at least one fatty alcohol alkoxylate to provide a dishwashing detergent composition;
b. Optionally adding at least one solid component to the the dishwashing detergent composition;
c. Packaging the dishwashing detergent composition in a water-soluble container to provide the package or device.

### TECHNICAL FIELD OF THE INVENTION

The present invention relates to packaged dishwashing detergent compositions. The invention further relates to methods of preparing such packaged dishwashing detergent compositions; uses of such packaged dishwashing detergent compositions for washing soiled kitchenware; and methods of washing kitchenware with such packaged dishwashing detergent compositions in an automatic dishwashing machine.

### BACKGROUND TO THE INVENTION

The aesthetic profile of a dishwashing detergent composition is of key importance to consumers' perception of a product's efficacy. Dishwashing detergent compositions with a pleasing aesthetic profile, i.e., having a smooth, continuous visual appearance, are significantly more appealing to consumers than compositions purely in granular, powder or tablet form. Dishwashing detergent compositions, especially those in the form of a gel, often comprise a thickening agent to attempt to provide a composition which a consumer will find visually pleasing, but which includes desired dissolution and ingredient release properties. A suitable thickening agent should provide a favourable stability profile, such that the dishwashing detergent composition exhibits good phase-stability during storage, primarily by having a high temperature of phase separation. The phase separation of a previously homogeneous gel upon aging or storage may convey to the consumer that the dishwashing detergent gel composition has declined in activity, decomposed, or is a poor-quality product, even if there is no degradation in activity or quality. Maintaining the visual appearance of a dishwashing detergent composition is, therefore, of significant importance.

Moreover, there has recently been an increased demand for more sustainable dishwashing detergent compositions to be produced, encouraging detergent manufacturers to substitute petro-based ingredients with materials based on renewable resources.

A typical thickening agent used in conventional dishwashing detergent compositions is a polyalkylene glycol. Of these, polyglycols having an ethylene oxide to propylene oxide ratio of 4:1, have been a popular choice. Despite their popularity, polyalkylene glycols of this type suffer from several disadvantages. They provide little contribution to the cleaning performance profile and shine performance profile of a dishwashing detergent composition. Furthermore, such thickening agents possess high viscosities and often require heating prior to usage. Their rheological properties are also non-ideal, making them relatively difficult to handle, and they can exhibit phase separation at room temperature.

Given the above disadvantages, there is a need for improved dishwashing detergent compositions that ameliorate these and/or other disadvantages of the prior art.

It is an aim of embodiments of the present invention to address one or more of the above problems by providing a dishwashing detergent composition, which offers one or more of the following advantages:
Improved phase-stability. Shows no or limited phase-separation, preferably even at storage conditions at higher than ambient temperatures.
Low-cost production.
Straightforward production. Preferably producible using standard processes and mixing equipment.
Ability to demonstrate a comparable or improved cleaning performance compared with current formulations, especially in automatic dishwashing applications.
Improved sustainability-profile.
Improved performance. Improved consumer-relevant performance benefits.
Improved handling.

It is also an aim of embodiments of the present invention to overcome or mitigate at least one problem of the prior art, whether expressly disclosed herein or not.

### SUMMARY OF THE INVENTION

According to a first aspect of the invention, there is provided a package or device comprising a water-soluble container in which is contained a dishwashing detergent composition comprising at least one fatty acid glucamide and at least one fatty alcohol alkoxylate, wherein the composition has a water content of <20 wt. %.

Such a dishwashing detergent composition beneficially provides a composition whereby polyglycol thickening agents can be removed, without compromising, and in fact enhancing, the cleaning performance profile and stability profile of the dishwashing detergent composition. Furthermore, such a composition is considerably cheaper to manufacture than many commonly used compositions containing polyglycol thickening agents.

Further advantageously, the invention provides a dishwashing detergent composition which exhibits limited phase separation at room temperature. As such, the composition of the invention exhibits a favourable stability profile compared to a conventional dishwashing detergent composition comprising a polyalkylene glycol. Further, the invention provides a dishwashing detergent composition which exhibits less phase separation than polyglycol-based compositions of the prior art at temperatures greater than room temperature. Thus, favourable aesthetics of the dishwashing detergent composition of the invention are maintained for the duration of typical storage.

The dishwashing detergent compositions of the invention also provide an improved sustainability-profile compared to commonly used polyglycol based formulations, via increased bio-based content and biodegradability. The dishwashing detergent compositions of the invention also benefit from straightforward production, which can be achieved using standard factory processes and mixing-equipment.

In some embodiments, the dishwashing detergent composition comprises less than 3 wt. %, less than 2 wt %, less than 1 wt. % or less than 0.5 wt. % polyalkylene glycol. In some embodiments the dishwashing detergent composition comprises substantially no polyalkylene glycol.

In some embodiments, the at least one fatty acid glucamide comprises a compound of Formula I, wherein R is a linear or branched, preferably a linear, saturated alkyl group comprising 7-25 and preferably 7-20 carbon atoms; or a linear or branched, preferably a linear, mono- or polyunsaturated alkenyl group comprising 7-25 and preferably 7-20 carbon atoms.

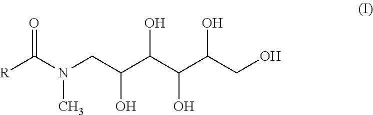

R may be a linear or branched, preferably a linear, saturated alkyl group or mono- or polyunsaturated alkenyl group, comprising 8-20 carbon atoms, or 10-20, 12-20, 14-20, 16-20, or 18-20 carbon atoms.

R may be a linear or branched, preferably a linear, saturated alkyl group or mono- or polyunsaturated alkenyl group, comprising 7-18 carbon atoms, or 7-16, 7-14, 7-12, 7-10, or 7-8 carbon atoms.

R may be a linear or branched, preferably a linear, saturated alkyl group or mono- or polyunsaturated alkenyl group, comprising 8-18 carbon atoms, or 10-18, 12-18, 14-18, 16-18, 8-16, 10-16, 12-16, 14-16, 8-14, 10-14, 12-14, 8-12, 10-12, or 8-10 carbon atoms.

In preferred embodiments, R is a linear or branched, preferably a linear, saturated alkyl group comprising 15-18, or 16-18 carbon atoms; or a linear or branched, preferably a linear, mono- or polyunsaturated alkenyl group comprising 15-18, or 16-18 carbon atoms.

In some embodiments where R is an alkenyl group, the or at least one double bond present in the alkenyl group may be in a cis or trans configuration, preferably a cis configuration.

In a preferred embodiment, R is a linear, saturated alkyl group comprising 17 carbon atoms. In another preferred embodiment, R is a linear, mono-unsaturated alkenyl group comprising 17 carbon atoms and a C—C double bond. The double bond may be present in any position in the alkenyl chain. In a particular embodiment, the double bond is present eight carbon atoms away from the carbonyl carbon. The double bond may be in a cis or trans configuration, preferably a cis configuration.

In some embodiments, the at least one fatty acid glucamide comprises sunflower oil methylglucamide.

In some embodiments, the at least one fatty acid glucamide is present at a concentration of no greater than 50 wt. % of the dishwashing detergent composition, or of no greater than 45, 40, 35, 30, 25, or of no greater than 20 wt. % of the dishwashing detergent composition.

In some embodiments, the at least one fatty acid glucamide is present at a concentration of 15 wt. % of the dishwashing detergent composition or less. In preferred embodiments, the at least one fatty acid glucamide is present at a concentration of 10 wt. % of the dishwashing detergent composition or less. The at least one fatty acid glucamide may be present at a concentration of 8 wt. % of the dishwashing detergent composition or less, or of 6, 4, or 2 wt. % of the dishwashing detergent composition or less.

The at least one fatty acid glucamide may be present at a concentration of at least 0.5 wt. % of the dishwashing detergent composition, or of at least 1, 1.5, 2, 2.5, 3, 3.5, 4, 4.5, or of at least 5 wt. % of the dishwashing detergent composition.

The at least one fatty acid glucamide may be present at a concentration of between 2-20 wt % of the dishwashing detergent composition, or preferably of between 5-15 wt % of the dishwashing detergent composition, or between 8-12 wt % of the dishwashing detergent composition.

Such fatty acid glucamide concentrations provide for optimal compatibility of the dishwashing detergent composition with the water-soluble container.

The above-described fatty acid glucamides allow for non-performance relevant thickening agents, such as polyglycols that are used in conventional dishwashing detergent compositions to be removed with conservation of the performance benefits of the benchmark compositions.

In some embodiments, the at least one fatty alcohol alkoxylate comprises a fatty alcohol portion derived from an alcohol comprising a linear or branched, preferably a linear, saturated C₈-C₃₆ alkyl group; or a linear or branched, preferably a linear, mono- or polyunsaturated C₈-C₃₆ alkenyl group.

In some embodiments, the fatty alcohol portion is derived from an alcohol comprising a linear or branched, preferably a linear, saturated C₁₀-C₂₂, preferably C₁₂-C₂₀ alkyl group; or a linear or branched, preferably a linear, mono- or polyunsaturated C₁₀-C₂₂, preferably C₁₂-C₂₀ alkenyl group.

The fatty alcohol portion may be derived from an alcohol comprising a linear or branched, preferably a linear, saturated alkyl group; or a linear or branched, preferably a linear, mono- or polyunsaturated alkenyl group, wherein the alkyl or the alkenyl group comprises 14-20 carbon atoms, or 16-20, 18-20, 12-18, 12-16, 12-14, 14-18, 16-18, or 14-16 carbon atoms.

In preferred embodiments, the fatty alcohol portion is derived from an alcohol comprising a linear or branched, preferably a linear, saturated C₁₂-C₁₈, or C₁₂-C₁₅ alkyl group; or a linear or branched, preferably a linear, mono- or polyunsaturated C₁₂-C₁₈, or C₁₂-C₁₅ alkenyl group.

The fatty alcohol portion may constitute more than 5%, more than 10%, more than 15%, more than 20%, or more than 25% by weight of the overall molecular weight of the fatty alcohol alkoxylate. The fatty alcohol portion may constitute less than 55%, less than 50%, less than 45%, less than 40%, less than 35%, or less than 30% by weight of the overall molecular weight of the fatty alcohol alkoxylate. The fatty alcohol portion may constitute between 10-40% by weight of the overall molecular weight of the fatty alcohol alkoxylate, or between 15-35%, or preferably between 20-30%, or most preferably between 24-28% by weight of the overall molecular weight of the fatty alcohol alkoxylate.

In some embodiments, the fatty alcohol alkoxylate is a fatty alcohol ethoxylate. The fatty alcohol ethoxylate may comprise 1-50, preferably 2-25, and more preferably 3-20 ethylene oxide units. The fatty alcohol ethoxylate may comprise a C₁-C₃₀, preferably C₅-C₂₅, more preferably C₁₀-C₂₀ alcohol portion; and 2-25, preferably 3-20 ethylene oxide units.

In some embodiments, the fatty alcohol alkoxylate is a fatty alcohol propoxylate. The fatty alcohol propoxylate may comprise 4-50, preferably 5-25, and more preferably 5-15 propylene oxide units.

In some embodiments, the fatty alcohol alkoxylate is a fatty alcohol butoxylate. The fatty alcohol butoxylate may comprise 4-50, preferably 5-25, and more preferably 5-15 butylene oxide units. The fatty alcohol butoxylate may comprise 1-15, or 1-10, or 1-5 butylene oxide units.

In some embodiments, the fatty alcohol alkoxylate comprises an alkoxylate portion with at least two different alkylene oxide monomer units.

In preferred embodiments, at least one of the at least two different alkylene oxide monomer units is a lower alkoxylate group than at least one other of the at least two different alkylene oxide monomer units. In preferred embodiments, the alkoxylate portion comprises a greater number of moles of the lower alkoxylate group than of the higher alkoxylate group.

By the term ‘lower alkoxylate’ it is meant an alkoxylate group having a lower number of carbon atoms. The term ‘higher alkoxylate’ refers to an alkoxylate group having a higher number of carbon atoms. Thus, for a fatty alcohol alkoxylate comprising ethylene oxide and propylene oxide groups, the ethylene oxide is the lower alkoxylate and the propylene oxide is the higher alkoxylate.

In some embodiments, one or more of the at least two different alkylene oxide monomer units are independently selected from the group comprising: ethylene oxide, propylene oxide, and butylene oxide.

In preferred embodiments, one of the at least two different alkylene oxide monomer units is ethylene oxide. The alkoxylate portion may comprise 3-50, preferably 3-25, and more preferably 3-20, or 5-15 ethylene oxide units.

In some embodiments, one of the at least two different alkylene oxide monomer units is propylene oxide. The alkoxylate portion may comprise 1-50, preferably 1-20, and more preferably 1-10 propylene oxide units.

In some embodiments, one of the at least two different alkylene oxide monomer units is butylene oxide. The alkoxylate portion may comprise 1-50, preferably 1-20, and more preferably 1-10 butylene oxide units.

In preferred embodiments, the alkoxylate portion comprises two different alkylene oxide monomer types. Preferably, one of the two different alkylene oxide monomer types is a lower alkoxylate and the other is a higher alkoxylate. The fatty alcohol alkoxylate may preferably have a mole ratio of the lower alkoxylate group to the higher alkoxylate group of at least 1.1:1, most preferably of at least 1.8:1, especially at least 2:1. It is also preferred that the fatty alcohol alkoxylate comprises between 3 to 5 moles of the higher alkoxylate group and between 6 to 10 moles of the lower alkoxylate group, preferably 4 or 5 moles of the higher alkoxylate and 7 or 8 moles of the lower alkoxylate, and most preferably 4 moles of the higher alkoxylate and 8 moles of the lower alkoxylate.

In preferred embodiments, the alkoxylate portion comprises at least one ethylene oxide unit and at least one propylene oxide unit. The alkoxylate portion may preferably comprise only ethylene oxide and propylene oxide units. The alkoxylate portion may comprise 5-15, 5-13, 5-11, 5-10, 5-9, or 5-8 ethylene oxide units; and 1-10, 1-8, 1-6, 1-5, or 1-4 propylene oxide units. The alkoxylate portion may comprise 5-15 ethylene oxide units and 1-10 propylene oxide units. The alkoxylate portion may comprise 5-11 ethylene oxide units and 1-6 propylene oxide units. The alkoxylate portion may comprise 5-8 ethylene oxide units and 1-4 propylene oxide units. The alkoxylate portion may preferably comprise 8 ethylene oxide units and 4 propylene oxide units. In preferred embodiments, the fatty alcohol portion is derived from an alcohol comprising a linear or branched, preferably a linear, saturated C₁₂-C₁₈, or C₁₂-C₁₅ alkyl group; or a linear or branched, preferably a linear, mono- or polyunsaturated C₁₂-C₁₈, or C₁₂-C₁₅ alkenyl group; and the alkoxylate portion comprises 5-8, preferably 8 ethylene oxide units; and 1-4, preferably 4 propylene oxide units.

In some embodiments, the alkoxylate portion comprises at least one ethylene oxide unit and at least one butylene oxide unit. The alkoxylate portion may comprise only ethylene oxide and butylene oxide units. The alkoxylate portion may comprise 5-15, 5-13, 5-11, 5-10, 5-9, or 5-8 ethylene oxide units; and 1-10, 1-8, 1-6, 1-5, or 1-4 butylene oxide units. The alkoxylate portion may comprise 5-15 ethylene oxide units and 1-10 butylene oxide units. The alkoxylate portion may comprise 5-11 ethylene oxide units and 1-6 butylene oxide units. The alkoxylate portion may comprise 5-8 ethylene oxide units and 1-4 butylene oxide units. The alkoxylate portion may preferably comprise 8 ethylene oxide units and 4 butylene oxide units.

In some embodiments, the alkoxylate portion comprises at least one propylene oxide unit and at least one butylene oxide unit. The alkoxylate portion may comprise only propylene oxide and butylene oxide units. The alkoxylate portion may comprise 1-10, 1-8, 1-6, 1-5, or 1-4 propylene oxide units; and 1-10, 1-8, 1-6, 1-5, or 1-4 butylene oxide units. The alkoxylate portion may comprise 1-10 propylene oxide units and 1-10 butylene oxide units. The alkoxylate portion may comprise 1-6 propylene oxide units and 1-6 butylene oxide units. The alkoxylate portion may comprise 1-4 propylene oxide units and 1-4 butylene oxide units.

In some embodiments, the alkoxylate portion comprises at least one ethylene oxide unit, at least one propylene oxide unit, and at least one butylene oxide unit. The alkoxylate portion may comprise only at least one of, or all of: ethylene oxide, propylene oxide, and butylene oxide units. The alkoxylate portion may comprise 5-15, 5-13, 5-11, 5-10, 5-9, or 5-8 ethylene oxide units; 1-10, 1-8, 1-6, 1-5, or 1-4 propylene oxide units; and 1-10, 1-8, 1-6, 1-5, or 1-4 butylene oxide units. The alkoxylate portion may comprise 5-15 ethylene oxide units, 1-10 propylene oxide units and 1-10 butylene oxide units. The alkoxylate portion may comprise 5-11 ethylene oxide units, 1-6 propylene oxide units and 1-6 butylene oxide units. The alkoxylate portion may comprise 5-8 ethylene oxide units, 1-4 propylene oxide units and 1-4 butylene oxide units.

The above-described fatty alcohol alkoxylates exhibit excellent wetting of plastic, glass, ceramic, and stainless steel; excellent temperature stability up to 90° C. for processing; good compatibility with other components in the dishwashing detergent composition; and stability in alkaline conditions.

In some embodiments, the dishwashing detergent composition comprises a fatty alcohol ethoxylate; and further comprises a fatty alcohol alkoxylate with an alkoxylate portion comprising two different alkylene oxide monomer types, as described above. Preferably, the alkoxylate portion of the fatty alcohol alkoxylate comprises ethylene oxide and propylene oxide units, as described above. In such embodiments, the fatty alcohol ethoxylate may comprise a C₁₀-C₂₅, preferably C₁₆-C₁₈ fatty alcohol portion; and 10-40, preferably 20-30 ethylene oxide units. In such embodiments, the fatty alcohol portion of the fatty alcohol alkoxylate is derived from an alcohol comprising a linear or branched, preferably a linear, saturated C₁₂-C₁₈, or C₁₂-C₁₅ alkyl group; or a linear or branched, preferably a linear, mono- or polyunsaturated C₁₂-C₁₈, or C₁₂-C₁₅ alkenyl group; and the alkoxylate portion comprises 5-8, preferably 8 ethylene oxide units; and 1-4, preferably 4 propylene oxide units.

The at least one fatty alcohol alkoxylate may be present at a concentration of at least 0.5 wt. % of the dishwashing detergent composition, or at least 1, 2, 3, 4, 5, 6, 7, 8, 9, 10, 15, 20, 25 or at least 30 wt. % of the dishwashing detergent composition.

The at least one fatty alcohol alkoxylate may be present at a concentration of no greater than 80 wt. % of the dishwashing detergent composition, or of no greater than 75, 70, 65, 60, or of no greater than 55 wt. % of the dishwashing detergent composition.

In some embodiments, the at least one fatty alcohol alkoxylate is present at a concentration of between 5-50 wt. %, preferably between 20-50 wt. % of the dishwashing detergent composition.

The at least one fatty alcohol alkoxylate may be present at a concentration of between 25-50 wt. %, or of between 30-50, 35-50, 40-50, or of between 45-50 wt. % of the dishwashing detergent composition.

The at least one fatty alcohol alkoxylate may be present at a concentration of between 20-45 wt. %, or of between 20-40, 20-35, 20-30, or of between 20-25 wt. % of the dishwashing detergent composition.

The at least one fatty alcohol alkoxylate may be present at a concentration of between 25-45 wt. %, or of between 30-45, 35-45, 25-40, 30-40, 35-40, 25-35, 30-35, or of between 25-30 wt. % of the dishwashing detergent composition.

In preferred embodiments, the at least one fatty alcohol alkoxylate may be present at a concentration of between 15-45 wt. %, of between 20-45 wt. %, of between 25-40 wt. %, or of between 25-35 wt. % of the dishwashing detergent composition.

In some embodiments, the dishwashing detergent composition has a water content of less than 19 wt. %, or of less than 18, 17, 16, 15, 14, 13, 12, or of less than 11 wt %. In preferred embodiments, the dishwashing detergent composition has a water content of less than or equal to 10 wt. %. The water content may be less than 9 wt. %, or less than 8, 7, 6, 5, 4, 3, 2, or less than 1 wt. %. In some embodiments, the dishwashing detergent composition may contain no water, or substantially no water.

A low water content confers high phase-stability and beneficial rheological properties upon the dishwashing detergent composition. This further allows for improved PVOH film compatibility and for increased amounts of solid ingredients to be suspended within the composition.

In some embodiments, the dishwashing detergent composition further comprises propylene glycol.

The composition may comprise propylene glycol at a concentration of at least 0.5 wt. %, or of at least 1, 2, 3, 4, 5, 10, 15, 20, or of at least 25 wt. %.

The composition may comprise propylene glycol at a concentration of no greater than 60 wt. %, or of no greater than 55, 50, 45, 40, or of no greater than 35 wt. %.

The composition may comprise propylene glycol at a concentration of between 25-35 wt. %.

The composition may comprise propylene glycol at a concentration of between 27-35 wt. %, or of between 29-35, 31-35, or of between 33-35 wt. %.

The composition may comprise propylene glycol at a concentration of between 25-33 wt. %, 25-31, 25-29, or of between 25-27 wt. %.

The composition may comprise propylene glycol at a concentration of between 27-33 wt. %, or of between 29-33, 31-33, 27-31, 29-31, or of between 27-29 wt. %.

In some embodiments, the dishwashing detergent composition comprises one or more additional components selected from the group comprising: builders, co-builders, bleaching agents, bleach boosters, bleach catalysts, anti-foaming agents, material care agents, and combinations thereof.

The composition may comprise a builder and/or co-builder. The composition may comprise one or more builders or co-builders selected from the group comprising: phosphates (such as sodium triphosphate), polycarboxylates, citrates (such as sodium citrate, which may be anhydrous), aminocarboxylates (such as methyl glycine diacetic acid (MGDA), or N,N-dicarboxylmethyl glutamic acid (GLDA)), dicarboxylic acid amines (such as iminodisuccinic acid (IDS)), alkali silicates (such as sodium silicate), carbonates (such as sodium carbonate), a phosphonate, and salts and/or combinations thereof. The builder may preferably comprise a citrate, preferably trisodium citrate. In some embodiments, the dishwashing detergent composition may be free of phosphate builders. In many countries, including the United States and in the European Union, phosphate builders are restricted, or the amount of phosphorous permitted in a detergent composition has been severely limited. Therefore, in preferred embodiments, the dishwashing detergent compositions are substantially phosphate-free.

Builders reduce the effect of water hardness by removing calcium and magnesium ions and increase the effectiveness of the detergent.

The builder may be present at a concentration of at least 1, 2, 3, 4, 5, 6, 7, 8, 9, 10, 11, 12, 13, 14, 15, 16, 17, 18, 19, 20, 25, 30, 35, 40, or at least 45 wt % of the composition. The builder may be present at a concentration of no more than 90 wt. % of the composition, or of no more than 85, 80, 75, 70, 65, 60, 55, 50, 45, 40, 35, 30, 25, or of more than 20 wt. %. The dishwashing detergent composition may comprise the builder in an amount between about 10 and about 80 wt. %, between about 15 and about 75 wt. %, between about 20 and about 70 wt. %, between about 25 and about 65 wt. %, between about 30 and about 60 wt. %, between about 35 and about 55 wt. %, or between about 40 and about 50 wt. % of the composition.

The composition may include a bleaching system comprising one or more bleaching agents, preferably in combination with one or more bleach boosters and/or one or more bleach catalysts. The one or more bleaching agent may be selected from the group comprising: an oxygen-releasing bleaching agent, a chlorine-releasing bleaching agent and mixtures thereof.

The bleaching agent may comprise the active bleach species itself or a precursor to that species. The bleaching agent may be selected from the group comprising: an inorganic peroxide, an organic peracid and mixtures thereof. The terms “inorganic peroxide” and “organic peracid” encompass salts and derivatives thereof. Inorganic peroxides include percarbonates, perborates, persulphates, hydrogen peroxide and derivatives and salts thereof. The sodium and potassium salts of these inorganic peroxides are suitable, especially the sodium salts. Sodium percarbonate is particularly preferred.

The active bleaching agent is preferably present in an amount of from about 5 to about 25% wt., from about 7 to about 23% wt., from about 9 to about 19% wt., or from about 11 to about 17% wt of the composition.

The composition may comprise one or more bleach boosters and/or bleach catalysts. Any suitable bleach booster may be included. The composition may comprise one or more bleach boosters selected from the group comprising: tetraacetylglycol Uril (TAGU), sodium nonaoyl oxybenzene sulphonate (SNOBS), sodium isononaoyl oxybenzene sulphonate (ISONOBS), n-nonanoylsuccinimide (NOSI), acetyl triethyl citrate (ATC), N-acyl caprolactams, short chain triglycerides (such as triacetin), and preferably tetraacetylethylenediamine (TAED), or combinations thereof. Any suitable bleach catalyst may be used, for example manganese acetate or dinuclear manganese complexes such as those described in EP 1741774 A1, the contents of which are incorporated herein by reference. The organic peracids such as perbenzoic acid and peroxycarboxylic acids e.g. phthalimidoperoxyhexanoic acid (PAP) do not require the use of a bleach activator or catalyst as these bleaches are active at relatively low temperatures such as about 30° C.

The bleach catalyst may be a manganese complex comprising 1,4,7-Triazacyclononane (TACN), or any derivatives of a TACN ligand, for example 1,4,7-trimethyl-TACN, manganese oxalate, manganese acetate or a dinuclear manganese complex, for example a dinuclear manganese complex comprising TACN or any derivatives of a TACN ligand, for example 1,4,7-trimethyl-TACN.

The bleach booster and/or bleach catalyst may be present in an amount of at least 0.1 w1% of the dishwashing detergent composition, or of at least 0.2, 0.3, 0.4, 0.5, 0.6, 0.7, 0.8, 0.9, 1, 1.5, 2, 2.5, 3, 3.5, 4, 4.5, or of at least 5 wt %.

The bleach booster and/or bleach catalyst may be present in an amount of no greater than 50 wt % of the dishwashing detergent composition, or no greater than 45, 40, 35, 30, 25, or of no greater than 20 wt %.

The bleach booster and/or bleach catalyst is preferably present in an amount of from about 5 to about 25% wt., from about 7 to about 23% wt., from about 9 to about 19% wt., from about 11 to about 17% wt, or from about 12 to about 15% wt of the composition. The bleach booster and/or bleach catalyst may be present in an amount of from about 0.5-20 wt % of the package or device, or from about 1-15 wt %, or from about 2-10 wt %, or from about 3-7 wt %, or from about 4-6 wt % of the package or device. The package may comprise the bleach booster and/or bleach catalyst in a total amount of at least 5 mg, or at least 10, 20, 30, 40, or at least 50 mg. the package may comprise the bleach booster and/or bleach catalyst in a total amount of no greater than 5 g, or of no greater than 4, 3, or of no greater than 2 g.

The composition may comprise a silicone-based anti-foaming agent, which may comprise an alkylated polysiloxane. The alkylated polysiloxane may be selected from the group comprising: polydimethyl siloxanes, polydiethyl siloxanes, polydibutyl siloxanes, phenyl methyl siloxanes, dimethyl silanated silica, trimethyl silanated silica, triethyl silanated silica, and combinations thereof.

The anti-foaming agent may be present in an amount of from about 0.01 wt. % to about 5 wt. %, or from about 0.05 wt. % to about 3 wt. %, or from about 0.05 wt. % to about 2 wt. %, or from about 0.05 wt. % to about 1 wt. %, or from about 0.1 wt. % to about 0.5 wt. %. In some embodiments, the dishwashing detergent composition may comprise substantially no anti-foaming agent. Absence of an anti-foaming agent results in a lower propensity of the dishwashing detergent composition for phase separation.

The composition may comprise one or more material care agents which are effective as corrosion inhibitors and/or anti-tarnish aids. The material care agent may be selected from the group comprising: metasilicate, silicate, bismuth salts, manganese salts, paraffin, pyrazoles, thiols, mercaptans, aluminum fatty acid salts, and preferably triazoles (such as benzotriazoles), or combinations thereof. The material care agent may comprise a silver and/or copper corrosion inhibitor. Preferred silver/copper corrosion inhibitors are benzotriazole (BTA) or bis-benzotriazole and substituted derivatives thereof. Other suitable inhibitors are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

The dishwashing detergent composition may comprise the material care agent in an amount of from 0.01% by weight to 5% by weight, 0.05% by weight to 3% by weight, 0.1% by weight to 2.5% by weight, 0.2% by weight to 2% by weight, 0.2% by weight to 1.5% by weight. 0.2% by weight to 1% by weight, 0.3% by weight to 0.8% by weight, or 0.4% by weight to 0.6% by weight of the composition. The dishwashing detergent composition may comprise the material care agent in an amount of no greater than 5 wt %, or of no greater than 3, 2.5, 2, 1.5, 1, 0.8, 0.6, 0.4, or of no greater than 0.2 wt %. The dishwashing detergent composition may comprise substantially no material care agent.

In some embodiments, the dishwashing detergent composition may comprise more than one material care agent. The composition may comprise different material care agents for different purposes, such as for preventing glass corrosion, preventing silver tarnishing, preventing aluminium corrosion, etc.

The dishwashing detergent composition may comprise at least one polymer, preferably at least one polycarboxylate. By the term ‘polycarboxylate’, we mean any polymeric species comprising a carboxylic acid or carboxylate groups available for chelation. The polycarboxylate polymer may be a homopolymer and/or a copolymer and/or a terpolymer.

The one or more polymer may be present in an amount of between about 3 and about 25% wt., between about 5 and about 20% wt., between about 6 and about 18% wt., between about 7 and about 16% wt., between about 8 and about 15% wt., or between about 9 and about 13% wt.

The polymer may be a polycarboxylate polymer comprising an itaconic acid copolymer.

The polymer may be a polycarboxylate polymer comprising an acrylic acid monomer.

The polymer may be a polycarboxylate polymer comprising an acrylic acid homopolymer. The homopolymer may have a molecular weight of between about 2,000 and about 10,000, between about 3,000 and about 9,000, or between about 4,000 and about 8,000. The homopolymer may be present in an amount of from about 0.1 to about 5% wt., from about 0.2 to about 4.5% wt., from about 0.3 to about 4% wt., from about 0.3 to about 3.5% wt., from about 0.4 to about 3% wt., from about 0.5 to about 2.5% wt., from about 0.6 to about 2% wt., or from about 0.7 to about 1.5% wt.

The at least one polycarboxylate may comprise a sulphonic acid monomer. The sulphonic acid monomer may be present in an amount of from about 4 to about 14% wt., from about 5 to about 13% wt., from about 6 to about 12% wt. or from about 7 to about 11% wt.

Preferred monomers containing sulphonic acid groups are those of the formula:

R¹(R²)C═C(R³)—X—SO₃H
in which R¹ to R³ mutually independently denote —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or denote —COOH or —COOR⁴, R⁴ being a saturated or unsaturated, straight-chain or branched hydrocarbon residue with 1 to 12 carbon atoms, and X denotes an optionally present spacer group which is selected from —(CH₂)ₙ— with n=0 to 4, —COO—(CH₂)ₖ— with k=1 to 6, —C(O)—NH—C(CH₃)₂— and CH(CH₂CH₃)—.

Preferred monomers of the above formula include, for example, those of the formulae;

H₂C═CH—X—SO₃H

H₂C═C(CH₃)—X—SO₃H

HO₃S—X—(R⁵)C═C(R⁶)—X—SO₃H
in which R⁵ and R⁶ are mutually independently selected from —H, —CH₃, —CH₂CH₃, —CH₂CH₂CH₃, —CH(CH₃)₂ and X denotes an optionally present spacer group which is selected from —(CH₂)ₙ— with n=0 to 4, —COO—(CH₂)ₖ with k=1 to 6, —C(O)—NH—C(CH₃)₂— and —C(O)—NH—CH(CH₂CH₃)—.

Preferred monomers containing sulphonic acid groups are here 1-acrylamido-1-propanesulphonic acid, 2-acrylamido-2-propanesulphonic acid, 2-acrylamido-2-methyl-1-propanesulphonic acid, 2-methacrylamido-2-methyl-1-propanesulphonic acid, 3-methacrylamido-2-hydroxypropane-sulphonic acid, allylsulphonic acid, methallylsulphonic acid, allyloxybenzenesulphonic acid, methallyloxybenzenesulphonic acid, 2-hydroxy-3-(2-propenyloxy) propanesulphonic acid, 2-methyl-2-propene-1-sulphonic acid, styrenesulphonic acid, vinylsulphonic acid, 3-sulphopropyl acrylate, 3-sulfopropyl methacrylate, sulphomethacrylamide, sulphomethylmethacrylamide and mixtures of the stated acids or the water-soluble salts thereof. Particularly preferred is 2-acrylamido-2-methyl-1-propanesulphonic acid.

The sulphonic acid groups may be present in the polymers entirely or in part in neutralized form, i.e. the acidic hydrogen atom of the sulphonic acid group may be replaced in some or all of the sulphonic acid groups with metal ions, preferably alkali metal ions and in particular with sodium ions. It is preferred according to the invention to use copolymers containing partially or completely neutralized sulphonic acid groups.

The molar mass of the sulphonic acid polymers may be varied in order to tailor the properties of the polymers to the desired intended application. The copolymers may have a molar mass of between about 2000 and about 200,000 g mol⁻¹, between about 4000 and about 25,000 g mol⁻¹, or between about 5000 and about 15,000 g mol⁻¹. The polymer preferably has a pH of from 3 to 5, such as from 3.5 to 4.5.

The polycarboxylate may be a copolymer comprising a sulphonic acid monomer and an acrylic acid monomer.

The at least one polycarboxylate comprises a maleic acid monomer. Such a polymer is preferably present in an amount of from about 0.1 to about 5 wt., from about 0.2 to about 4.5% wt., from about 0.3 to about 4% wt., from about 0.3 to about 3.5% wt., from about 0.4 to about 3% wt., from about 0.5 to about 2.5% wt., from about 0.6 to about 2%, or from about 0.7 to about 1.5% wt.

The polymer may have a viscosity of from about 500 to about 3000 mPa·s, from about 750 to about 2500 mPa·s, from about 1000 mPa·s to about 2000 mPa·s. Such a copolymer may have a molecular weight (Mw) of from about 10,000 to about 100,000 g mol⁻¹, from about 20,000 to about 80,000 g mol⁻¹, from about 30,000 to about 70,000 g mol⁻¹, or from about 45,000 to about 55,000 g mol⁻¹.

The polycarboxylate may be a copolymer comprising a maleic acid monomer and an acrylic acid monomer.

The acrylic acid-maleic acid copolymer may be formed from 2-propenoic acid and 2,5-furandione. The acrylic acid-maleic acid copolymer may have a pH of from 7 to 9, such as from 7.5 to 8.5, assessed by DIN19268.

The polymer may be an acrylic acid homopolymer, an acrylic acid-sulphonic acid, and/or an acrylic acid-maleic acid copolymer.

The polymer may comprise one or more polycarboxylate homopolymers and one or more polycarboxylate copolymers. The homopolymer(s) and copolymer(s) may be present in a ratio of from 1:20 to 1:2, preferably from 1:15 to 1:5.

The polymer may comprise polyepoxysuccinic acid (PESA) or derivatives thereof. Polyepoxysuccinic acid is also known as epoxysuccinic acid homopolymer, polyoxirane-2,3-dicarboxylic acid, 2,3-oxiranedicarboxylic acid homopolymer, or poly(1-oxacyclopropane-2,3-dicarboxylic acid); and has the general structure:

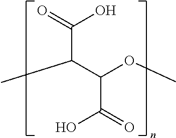

and where the derivatives thereof have the general structure:

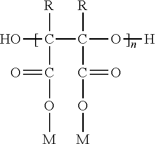

where R may be hydrogen or any organic chain (but preferably an ester such as C₁₋₄ alkyl) and where M may be any cation (preferably Na⁺, H⁺, K⁺, and/or NH₄⁺).

All references to PESA hereafter are to be taken to refer to polyepoxysuccinic acid or derivatives thereof, unless otherwise stated.

The PESA may have a molecular weight (Mw) of from about 100 to about 10,000 g mol⁻¹, from about 400 to about 2000 g mol⁻¹, from about 1000 to about 1800 g mol⁻¹. The PESA may have from about 2 to about 100 repeating monomer units, such as from about 2 to about 50, about 2 to about 45, about 2 to about 20 or from about 2 to about 10 repeating monomer units.

The polymer may comprise PESA in an amount of from about 0.1 to about 5% wt., from 0.1 about to about 4% wt., from about 0.15 to about 3% wt., from about 0.2 to about 1.9% wt., from about 0.25 to about 1.5% wt., or from about 0.6 to about 1.1% wt. PESA is preferably present in an amount of from about 5 to about 20% wt., from about 8 to about 19% wt., or from about 9 to about 15% wt., relative to the total quantity of polymers present.

The polymer may comprise any biodegradable polymer.

The biodegradable polymer may comprise, for example, Alcoguard® H 5941.

The biodegradable polymer may comprise a bio-based carbohydrate backbone, for example starch, cellulose or inulin. The polymer may comprise one or more synthetic, fossil-based grafting group.

The polymer may be a cationic, anionic or amphoteric polymer.

The dishwashing detergent composition may include one or more enzymes. It is preferred that the one or more enzymes are selected from protease, lipase, amylase, cellulase and peroxidase, with protease and amylase being most preferred. It is most preferred that protease and/or amylase enzymes are included in the compositions according to the invention as such enzymes are especially effective in dishwashing detergent compositions. More than one species of enzyme may be used. The total quantity of enzymes may be from about 1 to about 5% wt., from about 2 to about 4% wt., or about 3% wt.

The one or more enzyme may be present in an amount from about 1 to about 40% wt., from about 2 to about 38% wt., from about 4 to about 36% wt., from about 6 to about 34% wt., from about 8 to about 32% wt., from about 10 to about 30% wt., from about 12 to about 28% wt., from about 14 to about 26% wt., from about 16 to about 24% wt., from about 18 to about 24% wt. from about 20 to about 24% wt., from about 22 to about 24% wt., or about 23% wt. based on the weight of the dishwashing detergent composition.

The one or more enzyme may be present in an amount of at least 1, 2, 3, 4, 5, 6, 7, 8, 9, 10, 12, 14, 16, 18, 20, 22, 24, or at least 25% wt. based on the weight of the dishwashing detergent composition.

The composition may comprise protease in an amount from about 1 to about 40% wt., from about 2 to about 38% wt., from about 4 to about 36% wt., from about 6 to about 34% wt., from about 8 to about 32% wt., from about 10 to about 30% wt., from about 12 to about 28% wt., from about 14 to about 26% wt., from about 16 to about 25% wt., from about 18 to about 25% wt. from about 20 to about 25% wt., from about 21 to about 24% wt., from about 22 to about 24% wt., or about 23% wt. based on the weight of the dishwashing detergent composition.

The composition may comprise amylase in an amount be from about 1 to about 10% wt., from about 2 to about 8% wt., from about 4 to about 6% wt. or about 5% wt.

Any further traditional cleaning ingredients may be used as part of the dishwashing detergent composition. The dishwashing detergent composition may be free from, or substantially free from non-performance related ingredients.

In some embodiments, the dishwashing detergent composition is in the form of a powder, liquid, gel, tablet, pouch, or block.

In preferred embodiments, the dishwashing detergent composition is a gel.

The gel may comprise a solids content of at least 1 wt. %, or of at least 2, 3, 4, 5, 10, 15, 20, 25, 30, 35, 40, or of at least 45 wt. %. The gel may comprise a solids content of no greater than 80 wt. %, or of no greater than 75 wt. %. The gel may comprise a solids content of between 50-70 wt. %, preferably 50-65 wt. %. The solids content may be provided by the one or more additional components that are solids. These may comprise builders/co-builders, bleach boosters, and/or material care agents. In some embodiments, the one or more solid additional components may be suspended in the gel.

In some embodiments, the dishwashing detergent composition is an automatic dishwashing (ADW) detergent composition.

By the term ‘water-soluble container’ as used herein, it is meant a container which at least partially dissolves in water or disperses in water at 20° C. within 10 minutes to allow for egress of the contents of the package into the surrounding water.

In some embodiments, the package or device comprises a unit-dose format.

By ‘unit-dose’, it is meant that the product comprises one or more compositions in the quantity required for a single wash cycle of a machine dishwasher.

The water-soluble container may comprise or be a water-soluble film. The water-soluble film may be rigid or flexible at room temperature. The water-soluble film may be a thermoformed water-soluble film. The package or device of the invention may be a thermoformed package or device.

The water-soluble container may comprise or may be made of a poly(vinyl alcohol) (PVOH) film. The PVOH film may be partially or fully alcoholised or hydrolysed, for example, it may be from 40 to 100%, preferably 70 to 92%, most preferably about 85% to about 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water. The film may be cast, blown or extruded. It may further be unoriented, mono-axially oriented or bi-axially oriented.

The PVOH film may be a thermoformed PVOH film.

The package or device may be a multi-compartment container, preferably a water-soluble container. The dishwashing detergent or composition may preferably be located in at least one compartment of the multi-compartment container. The multi-compartment container may comprise two or more, three or more, four or more, five or more, or six or more separated compartments. Each of the compartments may be arranged side-by-side, concentrically, as sectors of a circle or in any suitable random or organised pattern. The container may comprise a first PVOH film comprising a pocket and a surrounding flange, and a second PVOH film, applied as a cover across the pocket and sealed across the flange. The container may comprise a first PVOH film comprising more than one pocket, for example two or more, three or more, four or more, five or more, or six or more pockets, and a surrounding flange, and a second PVOH film, applied as a cover across each pocket and sealed across the flange. In some embodiments there are three or four pockets.

Beneficially, a multi-compartment container allows compositions of different forms (i.e. solid form, liquid form or gel form) to be located within different compartments. Such a container is aesthetically more appealing to consumers.

The multi-compartment container may comprise solid, liquid, and gel components. The solid, liquid, and gel components may preferably be located in different compartments of the container. The gel component may be or may comprise the dishwashing detergent composition.

The multi-compartment container may comprise the dishwashing detergent composition of the invention and one or more additional components selected from the group comprising: builders, co-builders, bleaching agents, anti-foaming agents, material care agents, and combinations thereof. The one or more additional components may be as described above. The dishwashing detergent composition and the one or more additional components may be located in different compartments of the multi-compartment container. Alternatively, the dishwashing detergent composition of the invention and the one or more additional components may be located in the same compartment.

The multi-compartment container may comprise at least a first compartment and a second compartment. The multi-compartment container may comprise at least a first compartment, a second compartment and a third compartment. In addition to the dishwashing detergent composition of the invention, the multi-compartment container may comprise at least one further composition in the form of a solid, liquid, gel or paste. The at least one further composition in the form of a solid, liquid, gel or paste may comprise one or more cleaning actives selected from the list containing a builder, surfactant, alkalinity source, acidity source, enzyme, polymer, anti-corrosion agent, bleaching agent or care agent, or a mixture thereof.

The multi-compartment container may comprise at least a first compartment and a second compartment, and the dishwashing detergent composition of the invention may be located within the first compartment. The multi-compartment container may further comprise one or more of a solid, a gel, a gel comprising a suspension of a powder or granules, and a liquid, in addition to the dishwashing detergent composition of the invention. Each further composition may be located in its own separate compartment, or two or more further compositions may be co-located in at least one further compartment, for example.

The container may comprise at least one liquid cleaning active located within a second compartment. The at least one liquid cleaning active may be a bleaching system. The bleaching system may comprise a bleaching agent, for example a percarbonate, for example sodium percarbonate, a bleach booster, for example tetraacetylethylenediamine (TAED), and/or a bleach catalyst, for example a manganese complex comprising triazacyclononane (TACN), or any derivatives of a TACN ligand, for example 1,4,7-trimethyl-TACN, or manganese oxalate, manganese acetate or a dinuclear manganese complex, for example a dinuclear manganese complex comprising TACN or any derivatives of a TACN ligand, for example 1,4,7-trimethyl-TACN. The bleaching agent may comprise any bleaching agent described above. Above statements of invention relating to bleaching agents may be applied here.

The container may comprise at least one solid cleaning active located within a second compartment. The at least one solid cleaning active may be a bleaching system. The solid bleaching system may be in the form of a powdered solid. The solid, or powdered solid, bleaching system may be in the form of a coated granule or co-granule with one or more cleaning actives. The bleaching system may comprise a bleaching agent as described above. The bleaching agent may comprise any bleaching agent as described above.

The dishwashing detergent composition may comprise one or more cleaning actives selected from the list comprising: a builder, surfactant, alkalinity source, acidity source, enzyme, polymer, anti-corrosion agent, bleaching agent, material care agent, and mixtures thereof. Statements of invention found above relating to one or more of the above stated cleaning actives may be applied here. The one or more cleaning actives may be in granular form. The one or more cleaning actives may be in granular form suspended in the dishwashing detergent gel composition. The one or more cleaning actives may be at least one enzyme selected from the group comprising protease, amylase, lipase, cellulase and peroxidase, or mixtures thereof.

The container may comprise a first compartment comprising a gel comprising the dishwashing detergent composition and at least one enzyme (which may be one or more enzymes selected from an amylase, a protease, a cellulase and a lipase, preferably at least an amylase and a protease), and a second compartment comprising a solid or liquid composition, preferably a solid bleaching composition, and more preferably a bleaching composition in the form of a powder or granules. Preferably, the at least one enzyme has a slower rate of release from the gel comprising the dishwashing detergent composition of the invention than the rate of release of the one or more of the ingredients (for example, a cleaning active such as a bleaching composition) from the solid or liquid composition when the compartments rupture or dissolve. The at least one enzyme may have a timepoint of 80% release after the timepoint of 80% release of the one or more of the ingredients comprised in the solid or liquid composition when the compartments rupture or dissolve. The ‘timepoint of 80% release’ is typically measured as the timepoint of when a release of 80% of a particular ingredient (for example, a cleaning active or compound) has been reached. The at least one enzyme may have a timepoint of 80% release at least 1, 2, 3, 4, 5, 6, 7, 8, 9, 10, 12, 14, 16, 18, or at least 20 minutes after the timepoint of 80% release of the one or more ingredients comprised in the solid or liquid composition when the compartments rupture or dissolve. The timepoint of 80% release of the at least one enzyme may be between about 1 and about 30, between about 1.5 and about 28, between about 2 and about 26, between about 3 and about 24, between about 4 and about 22, or between about 5 and about 20 minutes after the timepoint of 80% release of any of the ingredients comprised in the solid or liquid composition when the compartments rupture or dissolve. Preferably, the timepoint of 80% release of the at least one enzyme is between about 3 and about 15 minutes after the timepoint of 80% release of any of the ingredients comprised in the solid or liquid composition when the compartments rupture or dissolve. Preferably, the ingredients comprised in the solid or liquid composition comprise a bleaching system. Advantageously, this means that the efficacy of the at least one enzyme is not inhibited, or at least not substantially inhibited, by any of the ingredients comprised in the solid composition, for example a bleaching composition. Moreover, the efficacy of any ingredients comprised in the solid or liquid composition, for example a bleaching composition, is not inhibited by the at least one enzyme, or inhibition is reduced, or that inhibition is reduced. Further advantageously, this means that there is a significant reduction in the number of ‘side reactions’ and production of by-products, which may otherwise inhibit performance of the at least one enzyme and/or any ingredients comprised in the solid or liquid composition. Additionally, the multi-compartment container may comprise a third compartment comprising a solid or liquid. The solid or liquid comprised in the third compartment may comprise one or more cleaning actives. Preferably, the at least one enzyme has a slower rate of release from the gel comprising the dishwashing detergent composition of the invention than the rate of release of the one or more of the cleaning actives comprised in the solid or liquid composition of the third compartment, when the compartments rupture or dissolve.

The dishwashing detergent composition in the first compartment preferably comprises at least one active ingredient, preferably an enzyme, more preferably amylase and/or protease, and the at least one active ingredient has a timepoint of 80% release of the active ingredient after a timepoint of 80% release of any solid or liquid cleaning active (such as a bleaching active) located within the second compartment when the compartments rupture or dissolve. The dishwashing detergent composition in the first compartment preferably comprises at least one active ingredient, preferably an enzyme, more preferably an amylase and/or protease, wherein the timepoint of 80% release of the at least one active ingredient is between about 1 and about 30 minutes after the timepoint of 80% release of any solid or liquid cleaning active (such as a bleaching active) located within the second compartment when the compartments rupture or dissolve.

In some embodiments, the package or device is a gel pack comprising the dishwashing detergent composition of the invention as a gel. The gel pack may also comprise one or more additional components selected from the group comprising: builders, co-builders, bleaching agents, anti-foaming agents, material care agents, and combinations thereof. The one or more additional components may be as described in the above statements of invention. The one or more additional components may be solid and may be suspended in the dishwashing detergent gel composition of the invention.

In some embodiments, the dishwashing detergent composition comprises at least 5 wt % of the package or device, or at least 10, 15, 20, 25, or at least 30 wt % of the package or device. In some embodiments, the dishwashing detergent composition comprises no greater than 99.9 wt %, or no greater than 95, 90, 85, 80, 75, or no greater than 70 wt % of the package or device. The dishwashing detergent composition may comprise between 5-80, 5-70, 10-60, 15-50, 20-45, or preferably between 30-40 wt %, or more preferably between 20-40 wt % of the package or device.

In general, the maximum dimension of the filled part of the package or device (excluding any flanges) may be between 5 cm and 12 cm, such as 10 cm or 8 cm. For example, a rounded cuboid container may have a length of 1 to 5 cm, especially 3.5 to 4.8 cm, for example 4.8 cm or 4.1 cm, a width of 1.5 to 4 cm, especially 3 to 4 cm, for example 3.7 cm or 3.9 cm, and a height of 1 to 2.5 cm, especially 1 to 2 cm, for example 1.25 to 1.75 cm.

According to a second aspect of the invention, there is provided a package or device comprising a water-soluble container surrounding a dishwashing detergent composition comprising at least one fatty acid glucamide and at least one fatty alcohol alkoxylate comprising an alkoxylate portion with at least two different alkylene oxide monomer units.

Statements of invention relating to the package or device of the first aspect of the invention or to any of its constituents may be applied mutatis mutandis to the package or device of the second aspect of the invention.

According to a third aspect of the invention, there is provided a method of preparing a package or device of the first aspect of the invention, the method comprising the steps of:
a. Mixing at least one fatty acid glucamide with at least one fatty alcohol alkoxylate to form dishwashing detergent composition;
b. Optionally adding at least one solid component to the dishwashing detergent composition; and
c. Packaging the dishwashing detergent composition in a water-soluble container to provide the package or device,
wherein less than 20% water is added to the composition during preparation.

Statements of invention relating to the package or device of the first aspect of the invention or to any of its constituents may also be applied to the third aspect of the invention.

According to a fourth aspect of the invention, there is provided a method of preparing a package or device of the second aspect of the invention, the method comprising the steps of:
a. Mixing at least one fatty acid glucamide with at least one fatty alcohol alkoxylate comprising an alkoxylate portion with at least two different alkylene oxide monomer units to form a dishwashing detergent composition;
b. Optionally adding at least one solid component to the dishwashing detergent composition; and
c. Packaging the dishwashing detergent composition in a water-soluble container to provide the package or device.

Statements of invention relating to the package or device of the first aspect of the invention may be applied mutatis mutandis to the fourth aspect of the invention.

The following statements relate to both the third and fourth aspects of the invention.

Step c) of the third or fourth aspect of the invention may comprise forming thermoforming a water-soluble sheet to form a pocket, into which pocket is deposited the dishwashing detergent composition, followed by applying and sealing a water-soluble cover over the filled pocket. The water-soluble sheet and cover may comprise a water-soluble film, and either or both may comprise PVOH. The PVOH may be as described herein above for the first aspect of the invention. In preferred embodiments both the pocket and cover comprise or consist essentially of PVOH. In some embodiments the pocket comprises a flange or rim extending outwardly around the periphery of the pocket, and the cover is sealed to the pocket at the flange or rim.

The at least one fatty acid glucamide may comprise the at least one fatty acid glucamide of the first aspect of the invention. Statements of invention relating to the at least one fatty acid glucamide of the first aspect of the invention may also be applied to the third and fourth aspects of the invention.

The at least one fatty alcohol alkoxylate may comprise the at least one fatty alcohol alkoxylate of the first aspect of the invention. Statements of invention relating to the at least one fatty alcohol alkoxylate of the first aspect of the invention may also be applied to the third and fourth aspects of the invention.

The at least one fatty acid glucamide and the at least one fatty alcohol alkoxylate may be liquid components.

Step (a) may comprise the step of mixing together the at least one fatty acid glucamide, the at least one fatty alcohol alkoxylate, and a further liquid component. The further liquid component may preferably comprise an anti-foaming agent. The anti-foaming agent may comprise any anti-foaming agent of the first aspect of the invention. statements of invention relating to the anti-foaming agents of the first aspect of the invention may be applied to the third and fourth aspects of the invention.

Step (a) may comprise mixing the components of the mixture at a speed of between about 200 and about 1500 rpm. The speed may be no greater than 150 rpm, or no greater than 200, 250, 300, 350, 400, 450, 500, 600, 700, 800, 900, 1000, 1100, 1200, 1300, 1400, or no greater than 1500 rpm. The speed may be at least 50 rpm, or at least 100, 150, 200, 250, 300, 350, 400, 450, or at least 500 rpm. The speed may preferably be between 150 rpm and 500 rpm, more preferably between 150 rpm and 300 rpm.

Step (a) may comprise mixing the components of the mixture with a jet stream mixer.

Step (a) may comprise mixing the components of the mixture for at least 5 seconds, or at least 10, 15, 20, 25, 30, 35, 40, 45, 50, 55 seconds, or for at least 1 minute, or at least 2, 3, 4, or at least 5 minutes. Step (a) may comprise mixing the components of the mixture for no greater than 30 minutes, or no greater than 25, 20, 15, 10, 5, 4, 3, 2, or no greater than 1 minute. Step (a) may comprise mixing the components of the mixture till said components are homogenized.

Before step (b), the mixture formed by step (a) may be homogenised. The homogenisation may comprise mixing the mixture formed by step (a) for between about 1 and 20 minutes, between about 2 and about 18 minutes, between about 4 and about 16 minutes, between about 6 and about 14 minutes, between about 8 and about 12 minutes, or about 10 minutes. The homogenisation may be carried out at up to 200, 300, 400, 500, 600, 700, 800, 900, 1000, 1100, 1200, 1300, 1400, 1600, 1800, 2000, 2200, or up to 2400 rpm.

The at least one solid component of step (b) may comprise one or more components selected from the group comprising: a builder, a co-builder, a bleaching agent, a bleach booster, a bleach catalyst, a material care agent, and combinations thereof. Statements of invention relating to the above components in the first aspect of the invention may be applied to the third and fourth aspects of the invention.

Step (b) may comprise adding a material care agent and builder to the mixture followed by adding a bleach booster.

Step (b) may comprise adding the at least one solid component to the mixture via a powder hopper.

In some embodiments, step (b) comprises adding the at least one solid component to the mixture under high shear mixing conditions.

Step (b) may comprise mixing the mixture after adding the at least one solid component at a speed of between about 500 and 3000 rpm. The speed may be at least 200 rpm, or at least 300, 400, 500, 600, 700, or at least 800 rpm. The speed may be no greater than 3000 rpm, or no greater than 2500, 2400, 2300, 2200, 2100, 2000, 1900, 1800, or no greater than 1700 rpm.

Step (b) may comprise mixing the mixture after adding the at least one solid component at a speed greater than in step (a).

The mixing conditions used during step (b) may cause the mixture to reach an elevated temperature without any external heating. The elevated temperature may be around 30-70° C., or around 50-70° C., or around 55-65° C. As such, the method may not require any external heating to sufficiently mix the components.

Step (b) may comprise mixing the components of the mixture for at least 5 seconds, or at least 10, 15, 20, 25, 30, 35, 40, 45, 50, 55 seconds, or for at least 1 minute, or at least 2, 3, 4, or at least 5 minutes. Step (b) may comprise mixing the components of the mixture for no greater than 30 minutes, or no greater than 25, 20, 15, 10, 5, 4, 3, 2, or no greater than 1 minute. Step (b) may comprise mixing the components of the mixture till a creamy gel results.

The method may comprise a further step of cooling the mixture formed after step (b). The mixture may be cooled to below 30° C., 28° C., 26° C., 24° C., 22° C., 20° C., 18° C., or below 16° C. The composition may preferably be cooled to room temperature, i.e. around 20-22° C.

An enzyme, such as an amylase and/or protease may be mixed with the dishwashing detergent composition; which may, for example, be either during or after the cooling step after step (b).

Step (c) may comprise packaging the dishwashing detergent composition using any suitable method employed in the art.

According to a fifth and sixth aspect of the invention, there is provided the use of a package or device of the first or second aspect of the invention, respectively, for washing soiled kitchenware.

Statements of invention relating to the package or device of the first aspect of the invention may also be applied mutatis mutandis to the fifth and sixth aspects of the invention.

The following statements relate to both the fifth and sixth aspects of the invention.

The kitchenware may comprise tableware, such as, for example, crockery, cutlery and the like.

Statements of invention relating to the package or device of the first aspect of the invention may also be applied mutatis mutandis to the seventh aspect of the invention.

According to a ninth and tenth aspect of the invention, there is provided a method of washing kitchenware in an automatic dishwashing machine, wherein a package or device of the first or second aspect of the invention, respectively, is added to the automatic dishwashing machine at the start of a main wash cycle or at the start of a pre-wash cycle.

Statements of invention relating to the package or device of the first aspect of the invention may also be applied mutatis mutandis to the ninth and tenth aspects of the invention.

The following statements relate to both the ninth and tenth aspects of the invention.

The package or device may be added to the automatic dish washing machine at the start of a main wash cycle or at the start of a pre-wash cycle. The package or device may be added to a dosing basket or a dosing chamber within the automatic dishwashing machine. The package or device may be placed on a floor of the automatic dishwashing machine.

### DETAILED DESCRIPTION OF THE INVENTION

In order that the invention may be more clearly understood embodiments thereof will now be described, by way of example only, with reference to the accompanying drawings, of which:

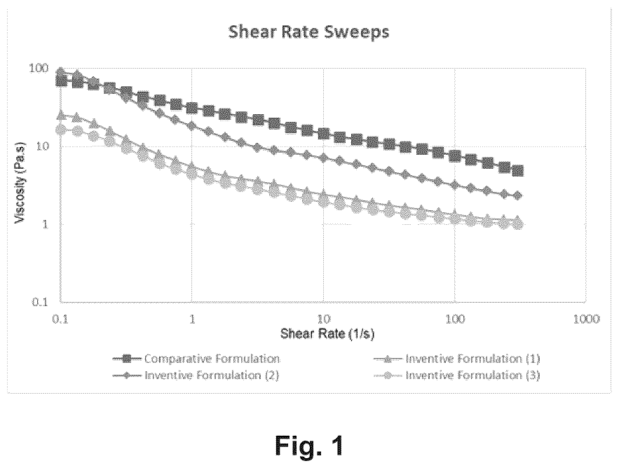

FIG. 1 displays the results of a shear rate sweep described in Example 7. Results are displayed as a logarithmic graph of composition viscosity (Pa·s) versus shear rate (1/s) for inventive dishwashing detergent compositions, (1)-(3), and for a comparative formulation.

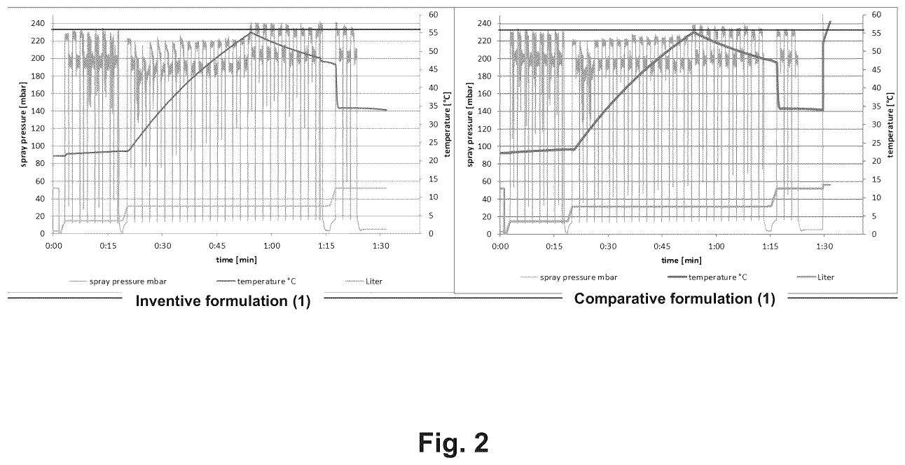

FIG. 2 displays the results of a foaming test performed on inventive dishwashing detergent composition (1) and a comparative formulation, as described in Example 8. The results display spray arm pressures, water temperatures and volumes of water.

### EXAMPLES

### Example 1—Preparation of Inventive Dishwashing Detergent Gel Compositions (1), (2), and (3)

A beaker was charged with a C₁₂-C₁₅ fatty alcohol alkoxylate containing ethylene oxide monomer units and propylene oxide units as described in the statements of invention above [(1): 32 g; (2): 26 g; (3): 35 g], a solution containing sunflower oil methylglucamide (fatty acid glucamide) (9 g of the solution; the solution having a fatty acid glucamide concentration of ˜50-60%) and anti-foaming agent (0.2 g). Subsequently, the solid components of the gel (see Table 1) were added in small portions under high shear mixing conditions. After the addition, stirring was continued for 5 minutes or until a creamy gel was obtained.

Upon returning to ambient temperature after mixing, the compositions exhibited a strong increase in viscosity and were able to fully suspend the solid ingredients.

Table 1 below provides an overview of the inventive dishwashing detergent compositions (1)-(3) and of a comparative known formulation.

TABLE 1

| | | Comparative | Inventive | Inventive | Inventive |
|---|---|---|---|---|---|
| | | Formulation/ | Composition | Composition | Composition |
| Ingredient | Function | wt. % | (1)/wt. % | (2)/wt. % | (3)/wt. % |
| Trisodium citrate | Builder | 42.9 | 43.9 | 49.9 | 40.9 |
| C₁₂-C₁₅ fatty alcohol | Surfactant | 32.0 | 32.0 | 26.0 | 35.0 |
| alkoxylate | (fatty | | | | |
| containing ethylene | alcohol | | | | |
| oxide units and | alkoxylate) | | | | |
| propylene oxide | | | | | |
| units | | | | | |
| Solution containing | Surfactant | — | 9.0 | 9.0 | 9.0 |
| sunflower oil | (fatty acid | | | | |
| methylglucamide | glucamide) | | | | |
| Polyalkylene glycol | Thickener | 10.0 | — | — | — |
| having an ethylene | | | | | |
| oxide:propylene | | | | | |
| oxide units ratio of | | | | | |
| 4:1 | | | | | |
| Others (optional | Material | 0.5 | 0.5 | 0.5 | 0.5 |
| ingredients) | Care Agent | | | | |
| | Anti- | 0.2 | 0.2 | 0.2 | 0.2 |
| | foamer | | | | |
| | Bleach | 14.4 | 14.4 | 14.4 | 14.4 |
| | booster | | | | |

### Example 2—Storage Trial

Samples of the inventive dishwashing detergent gel compositions, (1)-(3), and of the comparative formulation were subsequently placed in the following four separate storage trials for 6 weeks.

Storage trial 1: Temperature: 5° C.; Relative humidity: 50%

Storage trial 2: Temperature: 25° C.; Relative humidity: 50%

Storage trial 3: Temperature: 30° C.; Relative humidity: 65%

Storage trial 4: Temperature: 40° C.; Relative humidity: 75%.

In each trial, all inventive dishwashing detergent gel compositions showed an at least parity stability profile against the benchmark comparative formulation; inventive compositions (1) and (2) displayed an improved stability profile over the comparative formulation after 6 weeks storage at all temperatures. By ‘improved stability profile’, it is meant that there is no perceptible discolouration of the dishwashing detergent gel composition, no phase separation or no significant phase separation, over this timescale. The storage stability is measured by filling a PVOH pouch with the dishwashing detergent composition, sealing the pouch, and storing the sealed pouch in a sealed doy pack in a climate chamber under the aforementioned conditions.

A summary of the results is displayed in Table 2 below.

TABLE 2

| | | | |
|---|---|---|---|
| Comparative | Inventive | Inventive | Inventive |
| Formulation | Formulation (1) | Formulation (2) | Formulation (3) |

3 Weeks

| | | | | |
|---|---|---|---|---|
| 25° C./ | Gel: blue, strong phase | Gel: blue, slight phase | Gel: blue, slight phase | Gel: blue, slight phase |
| 50% | separation (2 phases) | separation (2 phases) | separation (2 phases) | separation (2 phases) |
| r.h. | PVOH: clear and gently | PVOH: clear and gently | PVOH: clear and gently | PVOH: clear and gently |
| | stiff | stiff | stiff | stiff |
| | | Better than comparative | Better than comparative | Better than comparative |
| 40° C./ | Gel: blue, strong phase | Gel: blue, phase | Gel: blue, phase | Gel: blue, phase |
| 75% | separation (2 phases) | separation (2 phases) | separation (2 phases) | separation (2 phases) |
| r.h. | PVOH: clear and stiff | PVOH: clear and stiff | PVOH: clear and stiff | PVOH: clear and stiff |
| | | Better than comparative | Better than comparative | Same as comparative |

6 Weeks

| | | | | |
|---|---|---|---|---|
| 25° C./ | Gel: blue, strong phase | Gel: blue, slight phase | Gel: blue, slight phase | Gel: blue, slight phase |
| 50% | separation (2 phases) | separation (2 phases) | separation (2 phases) | separation (2 phases) |
| r.h. | PVOH: clear and gently | PVOH: clear and gently | PVOH: clear and gently | PVOH: clear and gently |
| | stiff | stiff | stiff | stiff |
| | | Better than comparative | Better than comparative | Similar as comparative |
| 40° C./ | Gel: blue, strong phase | Gel: blue, phase | Gel: blue, phase | Gel: blue, phase |
| 75% | separation (2 phases) | separation (2 phases) | separation (2 phases) | separation (2 phases) |
| r.h. | PVOH: clear and stiff | PVOH: clear and stiff | PVOH: clear and stiff | PVOH: clear and stiff |
| | | Slightly better than | Better than comparative | |
| | | comparative | | |

This shows that the inventive dishwashing detergent compositions can be used to replace conventional formulations containing polyalkylene glycols (typically, a thickening-only ingredient). The stability profiles of the inventive dishwashing detergent gel compositions are largely unaffected and, in many cases, better than that of the conventional detergent composition comprising polyalkylene glycols. Inventive compositions (1) and (2), in particular, maintain an aesthetically pleasing profile for a longer duration, and do not undergo phase separation as readily, if at all, compared to the comparative formulation. It should be noted that the replacement of polyalkylene glycols, which have no surfactant functionality, with fatty acid glucamides, also enables the replacement of a non-functional filler ingredient with a detergent active ingredient.

### Example 3—Shine Test

The test was carried out using ballast soil to simulate soiled kitchenware. A beaker with 16 g defrosted soil was placed in the dishwasher at the beginning of each test.

The test was performed on glass (G), stainless steel (SS), and porcelain (PO) kitchenware.

The test was performed under the following conditions:

| | |
|---|---|
| Machine | Bosch |
| Program | Eco |
| Evaluation | after 5 washing cycles |
| Water hardness: | 21° GH |

Spotting and filming on the kitchenware was assessed by visual examination after washing and scored as follows:
5—extremely strong (least favourable); 4—very strong; 3—strong; 2—slightly; 1—no (most favourable).

The results of the test are summarised in Table 3 below.

TABLE 3

| | Comparative | | Inventive | | Inventive | |
|---|---|---|---|---|---|---|
| | Formulation | | Formulation (1) | | Formulation (2) | |
| | Spotting | Filming | Spotting | Filming | Spotting | Filming |
| Glass | 2.0 | 3.0 | 2.0 | 3.3 | 2.0 | 3.0 |
| Stainless | 2.0 | 2.0 | 2.0 | 2.5 | 2.0 | 2.0 |
| Steel | | | | | | |
| Porcelain | 2.0 | 2.5 | 2.0 | 2.5 | 2.0 | 2.0 |

Differences on spotting < 0.5 and differences on filming < 1.0 are considered insignificant.

The shine performance test indicated a parity performance of the inventive dishwashing detergent compositions versus the benchmark comparative formulation. No statistically significant differences were observed on glass and stainless steel spotting and filming.

### Example 4—Cleaning Performance Test

A cleaning performance test was carried out according to the IKW protocol (Miele 1223 GSL2, P3/8 min, 21° GH water hardness, 4 repetitions).

The cleaning performance was scored between 1 (worst performance) and 10 (best performance).

The results of the test are summarised in Table 4 below.

TABLE 4

| | | | | | Tea | | |
|---|---|---|---|---|---|---|---|
| | Crème | Milk | Minced | | with | Starch | Egg |
| | Brulee | Skin | Meat | Pasta | Milk | Mix | Yolk |
| Comparative | 9.9 | 6.3 | 9.9 | 9.0 | 5.4 | 9.2 | 7.0 |
| Formulation | | | | | | | |
| Inventive | 9.9 | 5.8 | 9.9 | 9.0 | 7.3 | 8.9 | 8.0 |
| Formulation | | | | | | | |
| (2) | | | | | | | |
| Inventive | 9.9 | 5.8 | 9.9 | 9.0 | 7.8 | 9.2 | 8.0 |
| Formulation | | | | | | | |
| (1) | | | | | | | |

Differences ≥ 1.0 scores are considered significant

The results demonstrate that the inventive dishwashing detergent compositions (1) and (2) show an overall parity performance profile compared to the comparative formulation.

### Example 5—Drying Performance Test

A drying performance test was carried out under the following test conditions:
Dishwasher: Miele GSL 2
Water hardness: 21° GH
Program: R50 3′ KL65
Soil: 50 g of a soil composed of a mixture of margarine, ketchup, gravy, egg yolk, potato starch, benzoic acid, milk, water
Detergent/Soil dosage: 1 Pouch and soil at opening of dosage chamber
Evaluation: 30 min after the end of the program (500-Watt halogen lamp)
Repetitions: 3 (no pre-conditioning)
Scoring Scale: 0=dry; 1=1 water drop; 2=2 water drops; 3=3 water drops; 4=4 water drops; 5=5 water drops; 6=>5 water drops. The water droplets were detected over 3 repetitions.

The results are displayed in Table 5 below.

TABLE 5

| | Plastic | Stainless Steel | Glass | Porcelain |
|---|---|---|---|---|
| | Droplets per | Droplets per | Droplets per | Droplets per |
| | piece | piece | piece | piece |
| Comparative | 3.6 | 0.4 | 1.7 | 2.1 |
| Composition | | | | |
| Inventive | 3.6 | 0.4 | 1.4 | 1.9 |
| Composition | | | | |
| (1) | | | | |

From the results above, it can be concluded that the inventive dishwashing detergent composition (1) provides an at least parity performance to the comparative composition and may even provide a directional consumer benefit in certain test conditions/on certain consumer-relevant surfaces.

### Example 6—Dissolution Test

Formulations were prepared using the inventive dishwashing detergent gel compositions (1)-(3) as unit-dose detergent gel compositions in water-soluble PVOH containers. The inventive dishwashing detergent gel compositions were independently contained in a multi-compartment package comprising the water soluble PVOH film container. The multi-compartment package had a first compartment containing a gel comprising the inventive dishwashing detergent compositions (1), (2), or (3). The package also had a second compartment comprising a bleaching system in the form of a powdered solid. The second compartment further comprised additional cleaning actives, for example alkalinity agents, co-builders and buffering agents, each in the form of a solid.

A dissolution test was performed to monitor the dissolution times of both the complete packages and of the gel compartments of the packages (containing inventive dishwashing detergent compositions), both before and after storage of the packages for 6 weeks. This was done in order to detect potential undesired degrading processes due to interactions between the PVOH containers and the inventive gel compositions.

The test was carried out under the following conditions: Erweka decay time tester; water temperature 40° C., tap water, 2 repetitions.

The results are displayed in Table 6 below.

TABLE 6

| | | Inventive | Inventive | Inventive |
|---|---|---|---|---|
| | Comparative | Formulation | Formulation | Formulation |
| | Formulation | (1) | (2) | (3) |
| 25° C./50% | | | | |
| r.h. | | | | |
| Opening of | 00:55 | 00:52 | 01:02 | 01:11 |
| Blue Gel | | | | |
| compartment | | | | |
| [mm:ss] | | | | |
| 30° C./65% | | | | |
| r.h. | | | | |
| Opening of | 01:04 | 00:57 | 00:59 | 01:02 |
| Blue Gel | | | | |
| compartment | | | | |
| [mm:ss] | | | | |
| 40° C./75% | | | | |
| r.h | | | | |
| Opening of | 01:03 | 00:30 | 01:03 | 00:54 |
| Blue Gel | | | | |
| compartment | | | | |
| [mm:ss] | | | | |

The results in this table were recorded after 6 weeks storage at the denoted conditions.

Surprisingly, all the inventive dishwashing detergent compositions remained stable over the investigated timeframe of 6 weeks, even at high moisture levels and elevated temperatures.

The freshly formulated gel samples of the inventive compositions displayed an opening time of the blue gel compartment of 1-2 minutes and a full dissolution time of the package of 2 minutes, both of which remained comparable throughout the storage study.

In contrast, the comparative composition displayed a rapid opening of the blue gel compartment—an effect that disappeared after 6 weeks of storage—while the overall dissolution of the product required 3-4 minutes.

In contrast, the comparative composition displayed a rapid opening of the blue gel compartment—an effect that disappeared after 6 weeks of storage—while the overall dissolution of the product required 3-4 minutes.

### Example 7—Rheological Characterisation

A rheological comparison was conducted between the comparative and inventive dishwashing detergent compositions to highlight any key differences which could aid in identifying potential issues that may occur during processing (mixing, pumping, dosing, etc.).

Testing was performed on a research rheometer (DHR2, TA Instruments) fitted with a temperature jacket and Brookfield V73 vane spindle measuring system (vane diameter 12.7 mm, vane length 25.3 mm, cup diameter 15.4 mm). Testing was performed at 25° C. The samples were mixed thoroughly with a spatula prior to testing.

### Shear Rate Sweeps

Following a 30 s equilibration time at 25° C. the samples were exposed to a shear rate sweep, 0.1 s⁻¹ to 300 s⁻¹, logarithmically scaled, 8 points per decade of shear rate, shear applied for 30 s at each rate with viscosity calculated over the final 5 s of each step.

A shear rate sweep of the comparative and inventive dishwashing detergent compositions was performed. The results are displayed in FIG. 1 and an overview provided in Table 7 below.

TABLE 7
Viscosity Values - at the highest and lowest shear
rates applied (avg. values of two measurements)

| | | Inventive | Inventive | Inventive |
|---|---|---|---|---|
| | Comparative | Composition | Composition | Composition |
| | Composition | (1) | (2) | (3) |
| Viscosity at | 69.5 | 25.2 | 86.5 | 16.3 |
| 0.1 s⁻¹ (Pa · s) | | | | |
| Viscosity at | 4.93 | 1.13 | 2.33 | 1.00 |
| 300 s⁻¹ (Pa · s) | | | | |

The results indicate that the samples reveal non-Newtonian shear thinning flow behaviours and display comparable viscosity profiles across the range of investigated shear rates.

### Example 8—Foaming Test

The inventive composition (1) and the comparative formulation were investigated in an in-machine test to check their foaming behaviour. The results are displayed in FIG. 2.

Both compositions revealed very similar profiles of the spray arm pressure throughout the wash cycle. Based on these results, the inventive compositions are considered no major risk for undesired foaming behaviour.

### Summary of Trials

In summary, the trials above demonstrate that the inventive dishwashing detergent compositions can adequately substitute the conventional compositions that contain expensive, non-performance relevant ingredients such as polyalkylene glycols, with retention of the performance benefits of the benchmark.

Moreover, storage tests revealed no change of aesthetics versus the comparative formulation and even enabled a slightly improved phase-stability.

The above embodiments are described by way of example only. Many variations are possible without departing from the scope of the invention as defined in the appended claims.

1. A package or device comprising a water-soluble container in which is contained a dishwashing detergent composition comprising at least one fatty acid glucamide and at least one fatty alcohol alkoxylate, wherein the composition has a water content of <20 wt. %.

2. The package or device as claimed in claim 1, wherein the at least one fatty acid glucamide comprises a compound of Formula I. 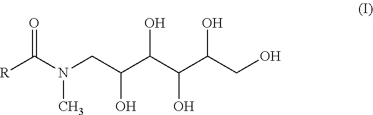
wherein R is a linear or branched saturated alkyl group comprising 7-25 carbon atoms; or a linear or branched mono- or polyunsaturated alkenyl group comprising 7-25 carbon atoms.

3. The package or device as claimed in claim 1, wherein the at least one fatty acid glucamide comprises sunflower oil methylglucamide.

4. The package or device as claimed in claim 1, wherein the at least one fatty acid glucamide is present at a concentration of 15 wt. % or less of the composition.

5. The package or device as claimed in claim 1, wherein the at least one fatty alcohol alkoxylate comprises a fatty alcohol portion derived from an alcohol comprising a linear or branched saturated C₈-C₃₆ alkyl group; or a linear or branched mono- or polyunsaturated C₈-C₃₆ alkenyl group.

6. The package or device as claimed in claim 1, wherein the fatty alcohol alkoxylate is a fatty alcohol ethoxylate.

7. The package or device as claimed in claim 1, wherein the fatty alcohol alkoxylate comprises an alkoxylate portion with at least two different alkylene oxide monomer units.

8. The package or device as claimed in claim 1, wherein the at least one fatty alcohol alkoxylate is present at a concentration of between 5-50 wt. % of the composition.

9. The package or device as claimed in claim 1, wherein the composition has a water content of less than or equal to 10 wt. %.

10. The package or device as claimed in claim 1, wherein the composition comprises one or more additional components selected from the group comprising: builders, co-builders, bleaching agents, bleach boosters, bleach catalysts, anti-foaming agents, material care agents, and combinations thereof.

11. The package or device as claimed in claim 1, wherein the composition is a gel and/or wherein the composition is an automatic dishwashing detergent composition.

12. The package or device as claimed in claim 1, wherein the package or device comprises a multi-compartment container, wherein the dishwashing detergent composition is located in at least one compartment.

13. A method of preparing the package or device according to claim 1, the method comprising the steps of:
a. Mixing at least one fatty acid glucamide with at least one fatty alcohol alkoxylate to provide a dishwashing detergent composition;
b. Optionally adding at least one solid component to the the dishwashing detergent composition;
c. Packaging the dishwashing detergent composition in a water-soluble container to provide the package or device.

14. Use of the package or device according to any claim 1 for washing soiled kitchenware.

15. A method of washing kitchenware in an automatic dishwashing machine, wherein the package or device of claim 1 is added to the automatic dishwashing machine at the start of a main wash cycle or at the start of a pre-wash cycle.

16. The package or device as claimed in claim 5, wherein the fatty alcohol portion is derived from an alcohol comprising a linear or branched saturated C₁₀-C₂₂ alkyl group; or a linear or branched mono- or polyunsaturated C₁₀-C₂₂ alkenyl group.

17. The package or device as claimed in claim 6, wherein the fatty alcohol alkoxylate comprises 1-50 ethylene oxide units.

18. The package or device as claimed in claim 7, wherein one or more of the at least two different alkylene oxide monomer units are independently selected from the group comprising: ethylene oxide, propylene oxide, and butylene oxide.

19. The package or device as claimed in claim 7, wherein at least one of:
the alkoxylate portion comprises 4 to 50 ethylene oxide units; and/or
the alkoxylate portion comprises 1 to 50 propylene oxide units.

20. The package or device as claimed in claim 12, wherein the multi-compartment container comprises solid, liquid, and gel components located in different compartments of the container, and wherein the gel component is or comprises the dishwashing detergent composition.
